(19) United States
(12) Patent Application Publication
(10) Pub. No.: US 2025/0085826 A1
(43) Pub. Date: Mar. 13, 2025

(54) A METHOD FOR DEPICTING THE REAR SURROUNDINGS OF A MOBILE PLATFORM COUPLED TO A TRAILER

(71) Applicant: Robert Bosch GmbH, Stuttgart (DE)

(72) Inventors: Raphael Cano, Stuttgart (DE); Jose Domingo Esparza Garcia, Stuttgart (DE)

(21) Appl. No.: 18/294,816

(22) PCT Filed: Jul. 26, 2022
(86) PCT No.: PCT/EP2022/070991

§ 371 Date: Feb. 2, 2024

(30) Foreign Application Priority Data
Aug. 12, 2021 (DE) 10 2021 208 825.2

(51) Int. Cl. G06F 3/0481; B60R 1/26

(52) U.S. Cl. CPC G06F 3/0481; B60R 1/26

(57) ABSTRACT

A method for depicting the rear surroundings of a mobile platform coupled to a trailer, wherein the mobile platform comprises a first rearward-facing camera. The method include: providing a first rearward image from the first rearward-facing camera; providing a second rearward image generated by means of a second rearward-facing camera; determining a trailer image region in the first rearward image in which a portion of the surroundings is obscured by the coupled trailer; and replacing at least a portion of the trailer image region in the first image with a partial image region of the second rearward image to depict the rear surroundings of the mobile platform.

### BACKGROUND INFORMATION

The automation of driving goes hand in hand with equipping vehicles with ever more extensive and powerful sensor systems for sensing their surroundings. Methods of machine learning are used for the classification and detection tasks when interpreting the sensor data. Convolutional neural networks are used for the video data, for instance.

Most surround view systems for acquiring the surroundings of a vehicle nowadays use four cameras. If a trailer is hitched to the vehicle, however, the rear view can become unusable and creates a large blind spot at the rear of the vehicle.

### SUMMARY

According to an example embodiment of the present invention, the above-described problem can be solved with a further, in particular fifth, camera system, which is mechanically coupled to a rear side of the trailer and is oriented against the direction of travel in order to show the area obscured by the trailer. With this fifth camera, the safety of the towing vehicle and trailer combination can be significantly improved, in particular if images from this fifth camera supplement the obscured portion of the rear camera of the towing vehicle. The fifth camera cannot replace the rear camera of the towing vehicle, however; in particular when maneuvering in reverse.

In an example scenario, 50% of the image of the rear camera occupied by the trailer occupies is obscured. This 50% of the image can be supplemented by images from the fifth camera if the respective section of the images from the fifth camera is projected onto the obscured region of the rear camera and makes the trailer appear transparent, so to speak.

However, this solution will only work if the trailer is aligned almost straight in relation to the towing vehicle. When the vehicle is turning with an angle of the trailer to the towing vehicle of more than 6°, for instance, the system is typically deactivated, so that only images from the rear camera or backup camera are visualized. This is a major limitation, because many critical situations with a trailer occur in parking situations when the articulation angle between the towing vehicle and the trailer is greater than 6°. In other words, the described solution is based on a pseudostatic overlay. Therefore, such a solution cannot hide the trailer correctly if a greater articulation angle occurs between the towing vehicle and the trailer as a result of cornering. In the previous methods, the shape of the trailer is set in advance and cannot be adjusted in real time if the camera sees the mechanically coupled trailer at a different articulation angle.

According to aspects of the present invention, a method for depicting the rear surroundings of a mobile platform coupled to a trailer, a system for depicting the rear surroundings of a mobile platform coupled to a trailer, a trained neural network, a control device, a mobile platform, and a computer program are provided. Advantageous configurations of the present invention are disclosed herein.

Throughout this description of the present invention, the sequence of method steps is presented in such a way that the method is easy to follow. However, those skilled in the art will recognize that many of the method steps can also be carried out in a different order and lead to the same or a corresponding result. In this respect, the order of the method steps can be changed accordingly. Some features are numbered to improve readability or to make the assignment more clear, but this does not imply a presence of specific features.

According to one aspect of the present invention, a method for depicting the rear surroundings of a mobile platform is provided, wherein the mobile platform is coupled to a trailer and comprises a first rearward-facing camera. According to an example embodiment of the present invention, the method for depicting the rear surroundings includes the following steps. In one step, a first rearward image from the first rearward-facing camera is provided. In a further step, a second rearward image generated by means of a second rearward-facing camera is provided, wherein the second rearward-facing camera in particular has a different perspective of the rear surroundings than the first rearward-facing camera in order to depict the rear surroundings more completely. In a further step, a trailer image region in the first rearward image is determined, in which a portion of the surroundings is obscured by the coupled trailer. In a further step, at least a portion of the trailer image region in the first image is replaced with a partial image region of the second image to depict the rear surroundings of the mobile platform.

The first rearward-facing camera can be a rear camera of the towing vehicle.

This method can advantageously be used to make the trailer “transparent” over a wide range of articulation angles, because the trailer can be identified in the first rearward image, for example by means of semantic segmentation, and replaced with subregions of the second rearward image and thus ensure a complete depiction of the rear surroundings of the mobile platform.

According to an example embodiment of the present invention, with dedicated hardware, the semantic segmentation can become sufficiently efficient and quick to carry out the semantic segmentation in real time.

When the trailer image region is determined using a trained neural network, the neural network has to be trained to carry out a semantic segmentation of the first rearward image. For this purpose, the neural network can be trained with reference images of standard trailer types from different viewing angles that correspond to the respective curve situations.

In other words, once the neural network has been trained, it is no longer necessary to adapt the trailer image region, on which at least a partial image region of the second rearward image is to be superimposed, to the different shapes of the trailer and situations with different articulation angles. The semantic segmentation algorithm recognizes the trailer in the first rearward image at pixel level. Based on the specific trailer image region, each trailer pixel can be replaced by the video information provided by the second rearward-facing camera, which can be mechanically coupled to the rear of the trailer. Using semantic segmentation, the contour of the trailer can be recognized not only in the application in which the vehicle and trailer combination are aligned straight, but also when the towing vehicle is turning and an articulation angle occurs between the towing vehicle and the trailer. The trailer image region can be replaced with the current video from the rear camera of the trailer, like a picture within a picture.

Alternatively or additionally, with the method according to an example embodiment of the present invention, a user can “zoom in” to the partial image region, for example using a touchscreen, if said image region is small, in order to have a better overview of the current situation. This achieves optimum resolution of the camera images.

With this method it is advantageously not necessary to adapt the shape of the trailer for each vehicle and each trailer.

The picture within a picture, corresponding to a “transparent” trailer, can be implemented at all articulation angles, so that the “transparent functionality” can be provided in all parking or driving situations with the trailer.

According to one aspect of the present invention, it is provided that the trailer comprises the second rearward-facing camera.

According to one aspect of the present invention, it is provided that the mobile platform comprises the second rearward-facing camera with a rearward-facing viewing angle which is different from that of the first rearward-facing camera.

According to one aspect of the present invention, it is provided that the second rearward-facing camera is a side camera of the mobile platform.

In other words, the method can also be used when the first rearward image is generated by side cameras. Even then, the trailer image region can be replaced by partial image regions of the second rearward image in order to make the trailer “transparent” in a depiction of the rear surroundings. For this purpose, it may be necessary to train the neural network with reference images that have been generated and labeled for this situation.

According to one aspect of the present invention, it is provided that the second rearward-facing camera is disposed on an exterior mirror of the mobile platform to visualize sides of the trailer, in particular including a rearward-facing side view, when making a turn.

According to one aspect of the present invention, it is provided that the trailer image region is determined by means of a trained machine learning system.

Examples of machine learning systems include a convolutional neural network, possibly in combination with fully connected neural networks, possibly using classic regularization layers and stabilization layers such as batch normalization and training drop-outs, using various activation functions such as sigmoid and ReLu, etc.; classic approaches such as support vector machines, boosting, decision trees, as well as random forests can also be used as machine learning systems for the described method.

In neural networks, the signal at a connection of artificial neurons can be a real number, and the output of an artificial neuron is calculated by a non-linear function of the sum of its inputs. The connections of the artificial neurons typically have a weight that adjusts as learning progresses. The weight increases or reduces the strength of the signal at a connection. Artificial neurons can have a threshold so that a signal is output only when the total signal exceeds this threshold.

A large number of artificial neurons are typically grouped in layers. Different layers may carry out different types of transformations for their inputs. Signals travel from the first layer, the input layer, to the last layer, the output layer; possibly after traversing the layers multiple times.

The architecture of such an artificial neural network can be a neural network that, if necessary, is expanded with further, differently structured layers like a multi-layer perceptron (MLP). A multi-layer perceptron (MLP) network belongs to the family of artificial feed-forward neural networks. MLPs generally consist of at least three layers of neurons: an input layer, an intermediate layer (hidden layer) and an output layer. That means that all of the neurons of the network are divided into layers.

In feed-forward networks, no connections to previous layers are implemented. With the exception of the input layer, the different layers consist of neurons that are subject to a nonlinear activation function and can be connected to the neurons of the next layer. A deep neural network can comprise many such intermediate layers.

According to one aspect of the present invention, it is provided that the trained machine learning system is a trained neural network for semantic segmentation of the first rearward image.

According to an example embodiment of the present invention, a method for generating a trained neural network for semantically segmenting objects of a digital first rearward image of the rear surroundings of a mobile platform with a plurality of training cycles is provided, wherein each training cycle comprises the following steps.

In one step, a digital first rearward image of the rear surroundings of a mobile platform comprising at least one trailer coupled to the mobile platform is provided. In a further step, a reference image associated with the digital first rearward image is provided, wherein the at least one trailer is labeled in the reference image. In a further step, the digital first rearward image is provided as an input signal to the neural network. In a further step, the neural network is adapted to minimize a deviation of the classification from the respective associated reference image during the semantic segmentation of the at least one trailer in the digital first rearward image.

The neural network is thus trained to standard trailer types and at different rearward viewing angles during the curve situation. The neural network can be a convolutional neural network.

Reference images are images that have in particular been taken specifically for training a machine learning system and have been manually selected and annotated, for example, or have been generated synthetically, and in which the majority of regions are labeled with respect to the classification of the regions. Such a labeling of the regions can, for instance, be carried out manually in accordance with the specifications of the classification, such as the at least two blindness attributes.

Such neural networks have to be trained for their specific task. Each neuron of the corresponding architecture of the neural network receives a random starting weight, for example. The input data is then entered into the network and each neuron can weight the input signals with its weight and passes the result to the neurons of the next layer. The overall result is then provided at the output layer. The magnitude of the error can be calculated, as well as the contribution each neuron made to that error, in order to then change the weight of each neuron in the direction that minimizes the error. This is followed by recursive runs, renewed measurements of the error and adjustment of the weights until an error criterion is met.

Such an error criterion can be the classification error on a test data set or also a current value of a loss function, for example on a training data set. Alternatively or additionally, the error criterion can relate to a termination criterion as a step in which an overfitting would begin during training or the available time for training has expired.

The optical image is provided to the trained neural network in digital form as an input signal.

With the thus trained neural network, the first rearward image can be semantically segmented in order to identify a pixel subregion in the first rearward image that shows the trailer. This subregion can then be replaced with a corresponding subregion of the second rearward image to depict the rear surroundings of the mobile platform.

According to an example embodiment of the present invention, the method can alternatively or additionally be carried out in the same way with a plurality of camera systems by merging the images of the camera systems.

According to an example embodiment of the present invention, a method is provided, in which, based on an above-described depiction of the rear surroundings of a mobile platform, a control signal for controlling an at least partially automated vehicle is provided; and/or a warning signal for warning a vehicle occupant is provided based on the first and/or the second error signal.

With respect to the feature that a control signal is provided based on a depiction of the rear surroundings of a mobile platform generated in accordance with one of the above-described methods, the term “based on” is to be understood broadly. It is to be understood such that any determination or calculation of a control signal is used depending on the depiction of the rear surroundings of the mobile platform, wherein this does not exclude that other input variables are used for this determination of the control signal as well. This applies accordingly to the provision of a warning signal.

According to an example embodiment of the present invention, a control signal can be provided when the specific trailer image region leaves set boundaries in the first rearward image, for example.

According to an example embodiment of the present invention, a system for depicting the rear surroundings of a mobile platform coupled to a trailer with a first rearward-facing camera and a second rearward-facing camera is provided. The system further comprises a data processing device for generating a depiction of the rear surroundings of the mobile platform comprising a first input for signals from the first rearward-facing camera and a second input for signals from the second rearward-facing camera and a computing unit and/or a system-on-chip, wherein the data processing device comprises an output for providing the depiction of the rear surroundings, and the computing unit and/or the system-on-chip is configured to carry out one of the above-described methods for depicting the rear surroundings.

According to an example embodiment of the present invention, a neural network which has been trained according to any of the above-described methods according to the present invention is provided.

According to an example embodiment of the present invention, a control device for use in a vehicle comprising a data processing device for generating a depiction of the rear surroundings of the mobile platform is provided. The control device comprises a first input for signals from the first rearward-facing camera and a second input for signals from the second rearward-facing camera. The control device further comprises a computing unit and/or a system-on-chip and an output for providing the depiction of the rear surroundings, wherein the computing unit and/or the system-on-chip is configured to carry out one of the above-described methods for depicting the rear surroundings.

With such a control device, the method for depicting the rear surroundings can easily be integrated into different systems.

According to an example embodiment of the present invention, a mobile platform, in particular an at least partially automated vehicle, which comprises an above-described control device according to the present invention is provided.

According to an example embodiment of the present invention, a computer program is provided, which includes commands that, when the computer program is executed by a computer, prompt said computer program to carry out the above-described method for depicting the rear surroundings.

Such a computer program enables the described method of the present invention to be used in different systems.

The term “mobile platform” can be understood to be an at least partially automated system that is mobile and/or a driver assistance system. One example can be an at least partially automated vehicle or a vehicle comprising a driver assistance system. In other words, in this context, an at least partially automated system comprises a mobile platform in terms of at least partially automated functionality, but a mobile platform also includes vehicles and other mobile machines including driver assistance systems. Other examples of mobile platforms can be driver assistance systems comprising a plurality of sensors, mobile multi-sensor robots, such as robot vacuum cleaners or lawnmowers, a multi-sensor monitoring system, a manufacturing machine, a personal assistant or an access control system. Each of these systems can be a fully or partially automated system.

### BRIEF DESCRIPTION OF THE DRAWINGS

Embodiment examples of the present invention are shown with reference to FIGS. 1A to 3B and will be explained in more detail in the following.

FIG. 1A shows a first rearward image from the first rearward-facing camera, wherein the towing vehicle is mechanically coupled to the trailer, according to an example embodiment of the present invention.

FIG. 1B corresponds to FIG. 1A wherein a trailer image region of the first rearward image showing the trailer has been determined, according to an example embodiment of the present invention.

FIG. 2A shows a first rearward image from the first rearward-facing camera, wherein the towing vehicle is mechanically coupled to the trailer with a large articulation angle, according to an example embodiment of the present invention.

FIG. 2B corresponds to FIG. 2A wherein a trailer image region of the first rearward image showing the trailer has been determined, according to an example embodiment of the present invention.

FIG. 3A shows a first rearward image from rearward-facing side cameras, wherein the towing vehicle is mechanically coupled to the trailer, according to an example embodiment of the present invention.

FIG. 3B corresponds to FIG. 3A wherein a trailer image region of the first rearward image showing the trailer has been determined, according to an example embodiment of the present invention.

### DETAILED DESCRIPTION OF EXAMPLE EMBODIMENTS

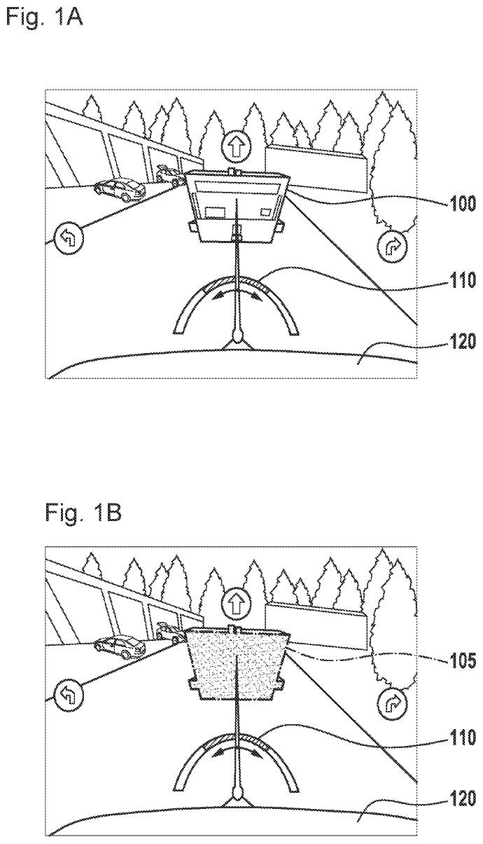

FIG. 1A schematically shows a first rearward image in a first scene provided by a first rearward-facing camera. The towing vehicle 120 is mechanically coupled to the trailer 100, wherein in the depiction the trailer 100 is aligned straight with an articulation angle 110 of 0°.

FIG. 1B schematically shows how the trailer image region 105 of the first rearward image according to FIG. 1A, which shows the trailer 100, was determined and marked with a pattern in order to be able to replace it with a partial image region of the second rearward image.

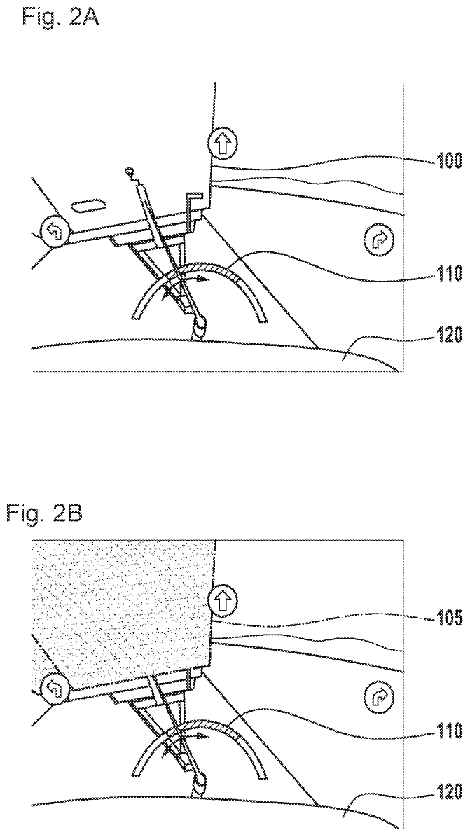

FIG. 2A schematically shows a first rearward image in a second scene provided by a first rearward-facing camera. The towing vehicle 120 is mechanically coupled to the trailer 100, wherein in the depiction the trailer 100 is being towed by the towing vehicle with a large articulation angle 110. Because the trailer occupies a larger trailer image region in the first rearward image in this case, the rear surroundings of the mobile platform can be seen only to a very limited extent.

FIG. 2B schematically shows how the trailer image region 105 of the first rearward image according to FIG. 2A, which shows the trailer 100, was determined and marked with a pattern in order to be able to replace it with a partial image region of the second rearward image.

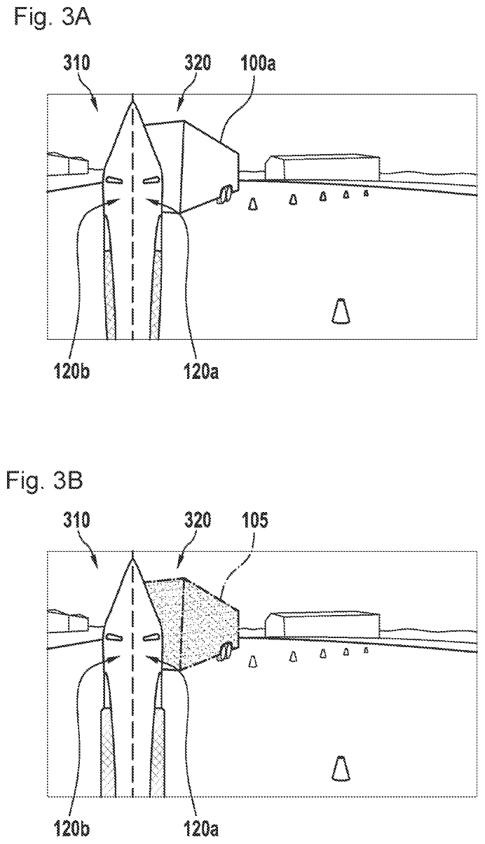

FIG. 3A schematically shows a depiction of the rear surroundings of a mobile platform in a third scene provided and generated by two rearward-facing side cameras. Since the towing vehicle is making a left turn, the image is partitioned in such a way that a first rearward image from the left side camera occupies a larger image portion 320 than a first rearward image from the right side camera 310. In this depiction, a left outer surface 120a and a right outer surface 120b of the towing vehicle can be seen. In this third scene, the towing vehicle is mechanically coupled to the trailer 100a with a large articulation angle. Here too, the trailer 100a blocks a view of the entire rear surroundings of the mobile platform.

FIG. 3B schematically shows how the trailer image region 105 of the first rearward image of the left side camera according to FIG. 3A, which shows the trailer 100a, was determined and marked with a pattern in order to be able to replace it with a partial image region of the second rearward image.

1-14. (canceled)

15. A method for depicting rear surroundings of a mobile platform coupled to a trailer, wherein the mobile platform includes a first rearward-facing camera, the method comprising the following steps:
providing a first rearward image from the first rearward-facing camera;
providing a second rearward image generated by a second rearward-facing camera;
determining a trailer image region in the first rearward image in which a portion of the surroundings is obscured by the coupled trailer; and
replacing at least a portion of the trailer image region in the first image with a partial image region of the second rearward image to depict the rear surroundings of the mobile platform.

16. The method according to claim 15, wherein the trailer includes the second rearward-facing camera.

17. The method according to claim 15, wherein the mobile platform includes the second rearward-facing camera with a rearward-facing viewing angle which is different from that of the first rearward-facing camera.

18. The method according to claim 17, wherein the second rearward-facing camera is a side camera of the mobile platform.

19. The method according to claim 18, wherein the second rearward-facing camera is disposed on an exterior mirror of the mobile platform to visualize sides of the trailer when making a turn.

20. The method according to claim 15, wherein the trailer image region is determined using a trained machine learning system.

21. The method according to claim 20, wherein the trained machine learning system is a trained neural network for semantic segmentation of the first rearward image.

22. A method for generating a trained neural network for semantically segmenting objects of a digital first rearward image of rear surroundings of a mobile platform with a plurality of training cycles, wherein each training cycle comprises the following steps:
providing a digital first rearward image of rear surroundings of a mobile platform including at least one trailer coupled to the mobile platform;
providing a reference image associated with the digital first rearward image, wherein the at least one trailer is labeled in the reference image;
providing the digital first rearward image as an input signal to the neural network; and
adapting the neural network to minimize a deviation of a semantic segmentation from the associated reference image during the semantic segmentation of the at least one trailer in the digital first rearward image.

23. The method according to claim 15, further comprising:
based on the depiction of the rear surroundings of the mobile platform, providing: (i) a control signal for controlling an at least partially automated vehicle and/or a (ii) warning signal for warning a vehicle occupant based on an error signal.

24. A system for depicting rear surroundings of a mobile platform coupled to a trailer, comprising:
a first rearward-facing camera;
a second rearward-facing camera; and
a data processing device configured to generate a depiction of the rear surroundings of the mobile platform including:
a first input for signals from the first rearward-facing camera,
a second input for signals from the second rearward-facing camera,
a computing unit and/or system-on-chip, and
an output for providing the depiction of the rear surroundings;
wherein the computing unit and/or the system-on-chip is configured to:
provide a first rearward image from the first rearward-facing camera,
provide a second rearward image generated by a second rearward-facing camera,
determine a trailer image region in the first rearward image in which a portion of the surroundings is obscured by the coupled trailer, and
replace at least a portion of the trailer image region in the first image with a partial image region of the second rearward image to depict the rear surroundings of the mobile platform.

25. A control device for use in a vehicle including a data processing device configured to generate a depiction of rear surroundings of a mobile platform, the control device comprising:
a first input for signals from a first rearward-facing camera;
a second input for signals from a second rearward-facing camera;
a computing unit and/or system-on-chip; and
an output configured to provide the depiction of the rear surroundings;
wherein the computing unit and/or the system-on-chip is configured to:
provide a first rearward image from the first rearward-facing camera,
provide a second rearward image generated by a second rearward-facing camera,
determine a trailer image region in the first rearward image in which a portion of the surroundings is obscured by the coupled trailer, and
replace at least a portion of the trailer image region in the first image with a partial image region of the second rearward image to depict the rear surroundings of the mobile platform.

26. An at least partially automated vehicle, comprising:
a control unit, including:
a first input for signals from a first rearward-facing camera;
a second input for signals from a second rearward-facing camera;
a computing unit and/or system-on-chip; and
an output configured to provide the depiction of the rear surroundings;
wherein the computing unit and/or the system-on-chip is configured to:
provide a first rearward image from the first rearward-facing camera,
provide a second rearward image generated by a second rearward-facing camera,
determine a trailer image region in the first rearward image in which a portion of the surroundings is obscured by the coupled trailer, and
replace at least a portion of the trailer image region in the first image with a partial image region of the second rearward image to depict the rear surroundings of the mobile platform.

27. A non-transitory computer-readable medium on which is stored computer program including instructions for depicting rear surroundings of a mobile platform coupled to a trailer, wherein the mobile platform includes a first rearward-facing camera, the instructions, when executed by a computer, causing the computer to perform the following steps:
providing a first rearward image from the first rearward-facing camera;
providing a second rearward image generated by a second rearward-facing camera;
determining a trailer image region in the first rearward image in which a portion of the surroundings is obscured by the coupled trailer; and
replacing at least a portion of the trailer image region in the first image with a partial image region of the second rearward image to depict the rear surroundings of the mobile platform.
